(19) United States
(12) Patent Application Publication
(10) Pub. No.: US 2007/0128011 A1
(43) Pub. Date: Jun. 7, 2007

(54) Hydraulic ram assisted unloading of pallets from fork lifting vehicles

(76) Inventor: Robert Scott Buckley III, Pompano Beach, FL (US)

Correspondence Address: Mark D. Bowen;Stearns Weaver Miller, et al., Suite 2100, 200 East Las Olas Boulevard, Fort Lauderdale, FL, 33301, US

(21) Appl. No.: 11/295,870

(22) Filed: Dec. 7, 2005

(51) Int. Cl. B66F 9/19

(52) U.S. Cl. 414/661

(57) ABSTRACT

A hydraulically actuated ram mechanism for pushing loaded pallets from the forks of a pallet jack lifting vehicle is disclosed. A hydraulically actuated ram including a push plate and a pair of hydraulic actuators is connected to the vehicle proximal the rear end of the forks. The hydraulic actuators are tied into the vehicles existing hydraulic system by installing a T-fitting and an electrically operated, normally closed hydraulic valve. The hydraulic valve includes an output port in fluid communication with each of the hydraulic actuators. The pallet jack operator controls the hydraulic ram using a switch electrically connected to the hydraulic valve. Upon activation of the switch, the hydraulic valve is opened and high-pressure hydraulic fluid is fed to each of the hydraulic actuators thereby causing the actuators to force the pallet off the forks. The hydraulic actuators may be retracted either by spring force, or by hydraulic pressure. In an alternate embodiment, the hydraulic ram may include multiple stages to achieve sufficient push plate travel.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to a load pushing mechanism for use in unloading pallets from pallet jacks and forklift vehicles.

2. Description of Related Art

A wide variety of goods are often transported and warehoused on wooden pallets. The goods are typically moved and handled using specialized vehicles adapted for lifting and moving fully loaded pallets. These vehicles, such as pallet jacks and forklifts, are typically wheeled vehicles having hydraulically actuated load-bearing forks that are capable of lifting the pallets upon insertion between the upper and lower pallet slats.

Oftentimes, however, the lift operator experiences difficulty in removing pallets from the lifting forks. This problem is particularly prevalent with pallet jack vehicles, as those vehicles typically have wheels projecting from the ends of each fork. Accordingly, the bottom of the pallet often catches on the wheels preventing the pallet from sliding off of the forks.

As a result of this problem, the prior art reveals a number of attempts directed to modifying lifting vehicles with mechanisms designed to push pallets off of the lifting forks.

For example, U.S. Pat. No. 2,787,393, issued to Horton, discloses an improved hydraulic load pushing and pulling mechanism for industrial trucks for moving loads onto and off the load platform of the truck. U.S. Pat. No. 3,182,836, issued to Sinclair, discloses a push-off attachment for use in removing a load from the tines of a forklift truck. U.S. Pat. No. 3,059,796, issued to Danserau, discloses a hydraulic system for removing materials from pallets. U.S. Pat. No. 3,640,414, issued to Brudi, discloses lift truck push-pull attachment for pulling loads onto the forks and discharging loads from the forks. U.S. Pat. No. 3,788,507, issued to Voss, discloses a lift truck adapted with a materials handling scoop having a push plate slidably mounted therein. Tongs connected to the back of the scoop and push plate are extended and retracted by a hydraulic cylinder. U.S. Pat. No. 4,268,210, issued to Ferguson, discloses an unloading mechanism for fork lifts in which a plate slides over the pallet on a fork lift and pushes the goods off the pallet. The plate is moved across the pallet by two arms connecting the plate to the forklift and operated by a hydraulic cylinder.

The devices disclosed in the prior art, however, are overly complex and not generally suited for use on smaller pallet jack vehicles. Accordingly, there exists a need for an improved pallet removal mechanism for use with a pallet jack.

### BRIEF SUMMARY OF THE INVENTION

The present invention overcomes the limitations and disadvantages present in the art by providing a hydraulically actuated mechanism for pushing loaded pallets from the forks of a forklift vehicle, particularly pallet jacks. In pushing pallet loads off the forks it is most desirable to apply the force directly to the pallet so as not to damage or topple the load. Accordingly, the present invention provides a hydraulically actuated ram comprising a push plate and a pair of hydraulic actuators connected to the vehicle proximal the rear end of the forks. The hydraulic actuators are tied into the vehicles existing hydraulic system by installing a T-fitting and an electrically operated, normally closed hydraulic valve. The hydraulic valve includes an output port in fluid communication with each of the hydraulic actuators. The pallet jack operator controls the hydraulic ram using a switch electrically connected to the hydraulic valve. Upon activation of the switch, the hydraulic valve is opened and high-pressure hydraulic fluid is fed to each of the hydraulic actuators thereby causing the actuators to force the pallet off the forks. The hydraulic actuators may be retracted either by spring force, or by hydraulic pressure. By providing dual hydraulic cylinders configured with output shafts directly coupled to the push plate, the present invention provides a powerful, yet compact, mechanism for pushing fully loaded pallets off of the forks. In an alternate embodiment, the hydraulic ram may include multiple stages to achieve sufficient push plate travel.

Accordingly, it is an object of the present invention to provide an improved hydraulic ram for pushing pallets from fork-type lift vehicles.

Another object of the present invention is to provide a compact, yet powerful, hydraulic ram that is easily installed on forklifts and pallet jacks.

Yet another object of the present invention is to provide a hydraulic ram having a pair of hydraulic actuators configured in parallel connection with a push plate.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a side perspective view of a pallet jack adapted with a hydraulic pallet ram in accordance with the present invention;

FIG. 2 is a top view of the pallet jack with a pallet disposed on the lifting forks;

FIG. 3 is a top detail view of the hydraulic pallet ram;

FIG. 4 is a schematic diagram of the hydraulic system;

FIG. 5 is a top detail view of a hydraulic pallet ram using double acting hydraulic cylinders;

FIG. 6 is a top detail view of a hydraulic pallet ram using single acting hydraulic cylinders; and

FIG. 7 is a perspective detail view of an alternate embodiment multi-stage hydraulic ram configuration.

### DETAILED DESCRIPTION OF THE INVENTION

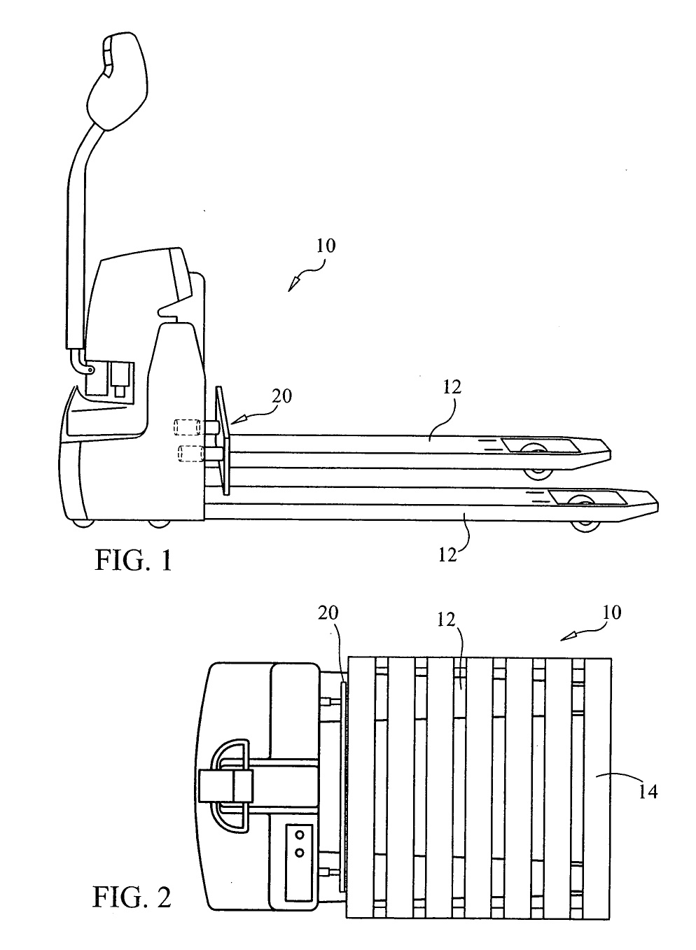

With reference now to the drawings, FIGS. 1-7 depict a pallet jack, referenced as 10, adapted with a hydraulic ram apparatus, generally referenced as 20, in accordance with the present invention installed in an operative configuration. Hydraulic ram 20 functions to assist the pallet jack operator in removing pallets from the forks 12 by applying a force that pushes loaded pallets 14 from the forks 12 of a forklift vehicle, particularly pallet jacks. In pushing palletized loads off the forks hydraulic ram 20 applies a horizontal force directly to pallet 14 while avoiding contact with the load so as to prevent damaging or tipping. The present invention will now be described in connection with a pallet jack vehicle, however, the presently disclosed apparatus is suitable for use with a wide variety of vehicles, including forklifts, and human-powered pallet jacks.

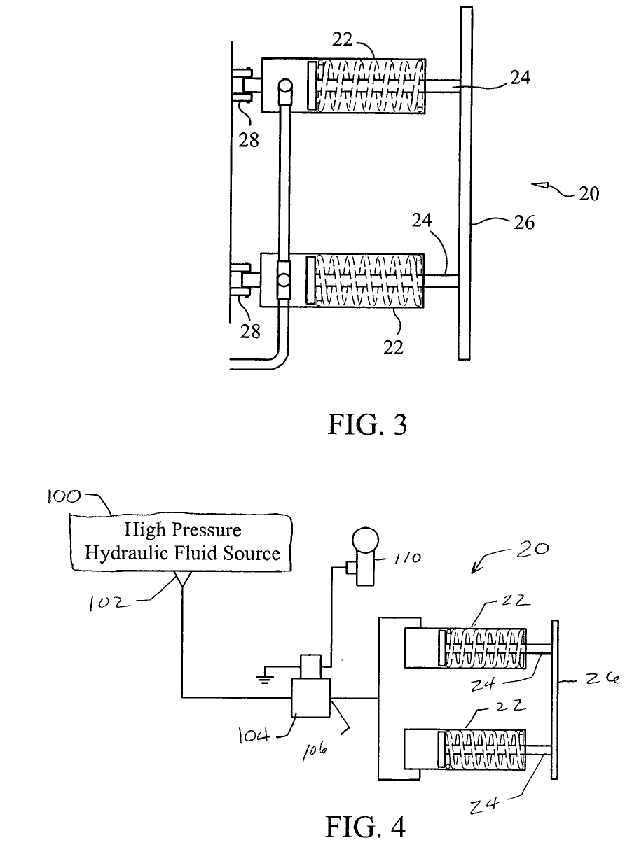

As best depicted in FIG. 3, hydraulic ram 20 preferably includes a pair of hydraulic actuators 22, each of which has an extendable/retractable output shaft 24 connected to a rigid push plate 26. Hydraulic actuators 22 are preferably connected to pallet jack 10 proximal the rear end of forks 12 by pivotal connection 28. Pivotal connection 28 allows the assembly freedom of pivotal movement about a generally horizontal pivot axis. In an alternate embodiment, hydraulic actuators 22 may be connected to pallet jack 10 by radial spherical bearings (not shown) to allow for greater freedom of movement. Output shafts 24 and the hydraulic actuator configuration are selected such that push plate 26 is capable of extending sufficiently to push a pallet 14 substantially off of forks 12 as more fully discussed herein below. In a preferred embodiment, sufficient extension is provided by single stage hydraulic actuation, however, in an alternate embodiment multi-stage hydraulic actuation may be used.

As best depicted in FIG. 4, hydraulic actuators 22 are preferably in fluid communication with the a high pressure hydraulic fluid source 100 of the pallet jack's existing hydraulic system by installation of a T-fitting 102 and an electrically operated, normally closed hydraulic valve 104. Hydraulic valve 104 includes an output port 106 in fluid communication with each of the hydraulic actuators 22. The pallet jack operator controls the hydraulic ram 20 using a switch 110 electrically connected to the hydraulic valve 104. Upon activation of switch 110, hydraulic valve 104 is opened and high-pressure hydraulic fluid is fed to each of the hydraulic actuators 22 thereby causing the actuator output shafts 24 to extend such that push plate 26 forces the pallet off the forks. By providing dual hydraulic cylinders configured with output shafts directly coupled to the push plate, the present invention provides a powerful, yet compact, mechanism for pushing fully loaded pallets off of the forks.

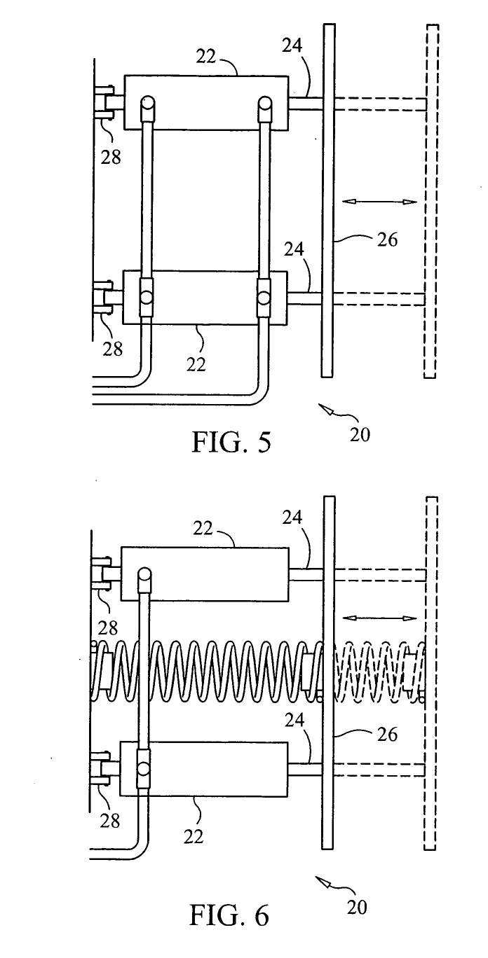

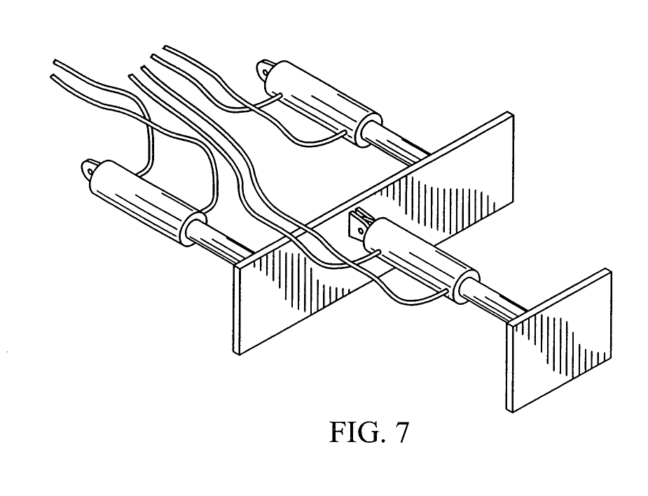

Hydraulic actuators 22 may be returned to the retracted configuration by any suitable retraction force. In a first embodiment depicted in FIGS. 3 and 4, retraction may be accomplished by use of a spring force. In this embodiment, a spring biases the output shaft to the retracted configuration. The spring may be either internal to the hydraulic actuator as depicted in FIGS. 3 and 4, or externally disposed as depicted in FIG. 6. In a second alternate embodiment retraction may be accomplished hydraulically by means of a second hydraulic connection to the actuator as depicted in FIGS. 5 and 7. In this embodiment, when the user deactivates the control switch, the hydraulic valve feeds high-pressure hydraulic fluid to the second hydraulic connection thereby forcing the output shaft to a retracted configuration. The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A hydraulic ram apparatus for unloading pallets from the forks of a pallet lifting vehicle of the type having a hydraulic lift system, said apparatus comprising:
a push plate;
at least one hydraulic actuator having a mounting end connected to the lifting vehicle and an output shaft connected to said push plate, said output shaft configurable between extended and retracted configurations whereby said push plate is extended and retracted relative to said forks;
said at least one hydraulic actuator having a hydraulic fluid inlet port connected to a hydraulic fluid supply line;
said hydraulic fluid supply line connected to a normally closed control valve;
said control valve in fluid communication with a source of high pressure hydraulic fluid; and
a control switch for actuating said control valve to an open position, whereby activation of said control switch opens said control valve and high-pressure hydraulic fluid is supplied to said at least one hydraulic actuator thereby extending said output shaft causing said push plate to unload a pallet from the vehicle.

2. A hydraulic ram apparatus according to claim 1, wherein said at least one hydraulic actuator is a single acting actuator returned by spring force.

3. A hydraulic ram apparatus according to claim 2, wherein said spring force is internally disposed within said at least one hydraulic actuator.

4. A hydraulic ram apparatus according to claim 2, wherein said spring force is externally disposed relative to said at least one hydraulic actuator.

5. A hydraulic ram apparatus according to claim 1, wherein said source of high pressure hydraulic fluid is internal to said vehicle.
